(19) United States
(12) Patent Application Publication
(10) Pub. No.: US 2025/0250146 A1
(43) Pub. Date: Aug. 7, 2025

(54) TAG LINES FOR LOAD CONTROL OF CRANES

(71) Applicant: ENABL A/S, Hedensted (DK)

(72) Inventor: Henrik VAGTHOLM, Gelsted (DK)

(21) Appl. No.: 18/856,105

(22) PCT Filed: Apr. 21, 2023
(86) PCT No.: PCT/DK2023/050098

§ 371 Date: Oct. 11, 2024

(30) Foreign Application Priority Data
Apr. 21, 2022 (DK) PA 2022 70210

(51) Int. Cl. B66C 13/06; B66C 1/10; B66C 23/18

(52) U.S. Cl. CPC B66C 13/06; B66C 1/108; B66C 23/185

(57) ABSTRACT

A combination including a crane and a load guiding arrangement arranged for mounting to the crane is provided. The crane includes a crane boom and the load guiding arrangement is arranged for controlling the orientation of a load suspended in a crane boom from a bearing wire about the bearing wire. Each tagline is connected to the load in a first and a second connection point for applying a controlled torque to the load about the bearing wire. The combination furthermore includes a crane counterweight and for each winch a winch frame, which is mounted directly on the crane next to or on the crane counterweight in positions at each side of the crane. The use of the load guiding arrangement in combination with the crane is also provided.

### CROSS-REFERENCE TO RELATED APPLICATIONS

This application is a national stage of PCT Application No. PCT/DK2023/050098, having a filing date of Apr. 21, 2023, which is based on DK Application No. PA 2022 70210, having a filing date of Apr. 21, 2022, the entire contents both of which are hereby incorporated by reference.

### FIELD OF TECHNOLOGY

The following relates to a combination comprising a crane and a load guiding arrangement arranged for mounting to the crane. The crane comprises a crane boom and the load guiding arrangement is arranged for controlling the orientation of a load suspended in a crane boom from a bearing wire about the bearing wire.

Each tagline is connected to the load in a first and a second connection point for applying a controlled torque to the load about the bearing wire.

The combination furthermore comprises a crane counterweight and for each winch a winch frame, which is mounted directly on the crane next to or on the crane counterweight in positions at each side of the crane.

The following further relates the use of the load guiding arrangement in combination with the crane.

### BACKGROUND

When lifting loads of a substantial size it is a requirement that the orientation of the load is controlled. Examples of such loads may be wind turbine blades, towers, prefabricated concrete elements for buildings, etc.

Due to the inertia of the load the load may maintain its position in space even when the bearing wire is rotated, i.e. if the crane boom is rotated. Therefore, an uncontrolled load may potentially impact the crane boom or impact personnel or structures close by. It is therefore a requirement that the load is controlled. This is effected by attaching a tagline to the load for applying a torque to the load about the bearing wire. The torque may be clockwise or counter-clockwise.

Due to the size of the loads, it is unsafe for personnel to handle the taglines and to apply the torque to the load about the bearing wire.

There is a need on the onshore wind turbine market to be able to control the load beneath the crane hook and it has not diminished as the wind turbines have become higher and the site placements are becoming more and more complex.

WO 2021/047745 A1 teaches a combination comprising a crane and a load guiding arrangement arranged for mounting to the crane. The combination provides for system which is easy to mobilize. The system does not comprise guide wires in the crane boom. However, on the onshore wind turbine market in cranes provided with guide wires there is a need for a system comprising a crane and a load guiding arrangement arranged for mounting to the crane. With the present invention this need is fulfilled.

### SUMMARY

An aspect relates to a simple and flexible load control system.

An aspect of embodiments of the invention is to provide a system which effectively avoids tortional forces on the crane boom.

These and other advantages are provided by a combination comprising a crane and a load guiding arrangement arranged for mounting to the crane, which crane comprises a crane boom and which load guiding arrangement is arranged for controlling the orientation of a load suspended in a crane boom from a bearing wire about the bearing wire, which combination comprises:
two winches, each of the winches have a bi-directional rotational spool, wherein the winches are placed on the crane,
two taglines with a first end of the tagline attached to the rotational spool, wherein each tagline is connected to the load in a first and a second connection point for applying a controlled torque to the load about the bearing wire, and
   each tagline is connected with the load through first or second load connection point so that each tagline extends at least from the spool to the first or second attachment point, where the combination furthermore comprises:
a crane counterweight (3) and
for each winch (7) a winch frame (16), which is mounted directly on the crane next to or on the crane counterweight (3) in positions at each side of the crane (1).

By the present combination is provided a simple and highly flexible solution which can meet the demands of for example wind turbine production.

The combination according to embodiments of the invention has more advantages:
is very simple,
is very easy to install on the crane,
will not limit the crane by adding many forces into the crane boom,
can be used on many crane types,
will secure a good control for the lifted load, both horizontal and vertical control,
will follow the crane movement,
can be used for sites with limited space and
no construction changes for the crane are needed.

In embodiments at least one guide wire is arranged on the crane along the crane boom. Depending on the intended use for example one or two guide wires may be attached.

The second end of each of the tag lines may either be fastened to one of the first and second load connection point respectively or alternatively the second end of the two tag lines is attached to the at least one guide wire in an attachment point. In case the second end of the tag lines are attached to one of the load connection points the tag lines extend from the spools to the load. In case the second end of the tag lines are attached to the guide wires in an attachment point the tag lines extend from the spools to the attachment point on the guide wires. The second end of the tag lines may be attached directly to the load or to the guide wires or indirectly by e.g. a traverse or a spacer.

In embodiments each winch frame (16) is designed with a form corresponding the form of counterweight blocks (17) and is attached to the crane counterweight (3) in a position between the counterweight blocks (17).

The placement of the tagline winches is provided in a position in which installation is easy and fast.

The winch may be an electronic driven winch or a hydraulic driven winch.

The winches are placed on the crane on each side of the crane boom and so they will follow the crane movement when the crane is moving inclusive yawing. The winch frame may be designed in such way that it fit to the crane, e.g. it may be designed to be placed directly on the crane counterweight whereby the crane needs no modification for mounting the winch frame.

By using the winch frame, it is possible, when assembling the crane on a site where it shall be used, to place the winch frame on the rack for the crane counterweight. The crane counterweight blocks will be lifted free from the crane during transport and be mounted when the crane is assembled on the site where the crane is to be used. Accordingly, the combination does not need specific crane approvals as the winch frame and the winch placed on the crane may be considered to be a part of the crane counterweight. It is noted that a crane approval is needed, however it is expected that an approval may be obtained as a type approval, whereby different types of cranes will be approved to the load guiding arrangement according to embodiments of the invention.

Moreover, the winches may be placed on the crane as a part of the normal routine for mounting the counterweight blocks.

A counterweight block normally has a weight between 8 and 15 tons. And typically, 20 counterweight blocks or more are used. The winch used will typically have a weight between 3 and 5 tons. The winch will only contribute to the weight in very limited size. Accordingly, the weight of the winch may be negligible and thus reduce or omit the need for specific crane approvals.

The winch frame needs not to be mounted with screws to the crane. It may be kept on place by the weight of the crane counterweight.

Alternatively, it is also possible to produce a frame which is welded to the crane and therefore may constitute a part of the crane, and which will be used for the mounting of the winch.

A generator/power supply for the winches can be placed on the crane's service platform or on the winch frames.

The power supply for the winches may alternatively be delivered from the crane and may be electrical or hydraulic power supply.

The tagline load connection points may be e.g. be chosen be arranged with snatch blocks, connection eyes, shaft connections, roll connections or the like elements allowing the tagline to roll or slide around the redirection means during raising or lowering the load (in case the second end of the tag lines are attached to the guide wires) or to releasable fasten the second end of the tag lines to the load (in case the second end of the tag lines are attached to the load connection points).

If the attachment point is movable along the at least one guide wire, the attachment point may follow the vertical position of the load as the load is lifted and/or lowered. This means, that the forces acting on the load may be at least partly in the horizontal plane even as the load is moved up/down allowing constant good control and preventing unintended twisting of the load and any unintended force son e.g. the crane boom resulting hereof.

The control of forces is especially relevant as the crane boom in itself has strength in the longitudinal direction; however, the crane boom is not suited for twisting movements or torsional movements.

With the combination according to embodiments of the invention the mobilization may comprise or consist of two tagline winches and possible one power generator and a control cabinet. Therefore, the load guiding arrangement is very simple and very easy to install on the crane and may be used on many crane types. All parts may be made for handling with trucks, cherry picker, hand or crane.

The combination may furthermore comprise a yoke for supporting the load (4) in which case optionally the two tagline connection points means (9) are connected with the load via the yoke.

The mutual distance between the two tagline load attachment points may in embodiments be larger than the mutual distance between the two winches (7).

For example, the mutual distance between the two tagline load connection points is between 8and 20 m and/or that the mutual distance between the two winches (7) is between 4 and 12 m. The combination may comprise a control system (18) in which case the that the winches (7) are controlled by the control system.

In embodiments a mast redirection point is arranged between each of the rotational spools and each of the first and second load connection point.

Accordingly, a tension sensor may be used for measuring the tension occurring in the taglines. These measurements may be treated in the control unit in order to activate a motor in the winch and thereby activate the rotation of the rotation spool.

In other words, embodiments of the system may be operated as follows. The tagline is applying a torque about the bearing wire to the load. The tagline is flexible, so the tagline is in tension.

The tagline force is tree-dimensional with two perpendicular horizontal components and a vertical component (z-component). One of the horizontal components (x-component) is directed from the load connection points on the load towards the bearing wire and the other (y-component) from the load connection points and perpendicular to the x-component. The controlled torque about the bearing wire is applied in a horizontal plane. The torque is composed by the y-component of the tagline force and the distance to the bearing wire (moment arm). The winch is located sufficiently far from the load in the direction of the y-component to apply the necessary torque to control the load. The necessary distance is dependent of how much tagline force the winch is rated at, the moment of inertia of the load, the distance between the load connection points and the bearing wire, the maximum lifting height and/or external forces ex the wind forces.

The relative relationship between the distance between the winch and the load is as follows: a relatively long distance allows for a lower tagline force, a higher moment of inertia, a shorter moment arm, a higher maximum lifting height and/or higher external forces, whereas a winch located closer to the load needs a higher rating, less moment of inertia, a longer moment arm, a lower maximum lifting height and/or lower external forces.

The winches are arranged on opposite sides of the crane boom and thus on opposite sides of the bearing wire. The winches are arranged such that they apply opposite directed torque to the load. For example, a first winch applies a clockwise torque, and a second winch applies a counter-clockwise torque: the first winch applies a counter-clockwise torque and the second winch applies a clockwise torque. When the sum of torque applied by the winches equal zero the load will maintain its orientation about the bearing wire.

The first and second winches may be located with an equal moment arm and symmetrical position in relation to the bearing wire or a different moment arm and an asymmetrical position in relation to the bearing wire. The control system is able to compensate during controlling of motors of the winches.

The load guiding arrangement is typically used for controlling the orientation of a load of substantial size and/or weight suspended from a bearing wire about the bearing wire. Examples of such loads may be wind turbine blades, towers, prefabricated concrete elements for buildings, etc. or other load with a large moment of inertia.

The load may be suspended from a crane with a bearing wire. The bearing wire may have an attachment means for connection to the load or a lifting frame attached to the load. For example, the attachment means may be a hook.

Each winch may have a hydraulically or electrically driven winch motor driving the spool. The spool is able to rotate bi-directional either by a gearing or bi-directional rotation of the winch motor. The tagline, which may be a wire, cable or for example a rope, is wound around the spool. The tagline is provided with attachment means for attachment to the attachment bracket.

A control system is provided for controlling the operation of the winch motors. The winch motors may operate simultaneously with the same or dissimilar rotation speeds. Thus, the winch motors may operate individually. The control system comprises tension sensor means for determining the tension in the taglines and spool rotation sensor means for determining the position and the operation of the spool. The sensors are operating continuously during use of embodiments of the system to provide feedback of the operation to the control system.

The control system may be provided with an output means for providing the sensor measurements to the crane operator or a data logger. Furthermore, the control system may be provided with warning signals provided to the crane operator, when pre-set limits are about to be-/are exceeded This will enable the crane operator to interrupt the lifting and bring the load into a safe condition if for example the wind conditions change and exceeds a predefined limit.

In order to obtain a larger distance between attachment points at the guide wire a traverse could be used. The traverse will be attached to at least one of the guide wires. This is a technically simple solution to obtain a wider distance between the attachment points and may be installed without specific crane approval, cf. comments above regarding crane approval.

In an embodiment the combination according to the invention is peculiar in that each winch frame may be designed with a form corresponding to the form of counterweight blocks and is attached to the crane counterweight in a position between the counterweight blocks.

Alternatively, the winch frame may be embodied in other ways. The winch plate may be embodied in a way which makes it possible to attach the winch plate in or at the counterweight, e.g. on top of the stack of the counterweight blocks.

The most convenient way to provide the winch frame is to have a form corresponding to the form of the counterweight blocks. Hereby it is very simple to mount the winch as the winch frame is inserted in the stack of counterweight blocks. In an embodiment, the winch frame will be mounted with one or more counterweight blocks on top of the winch frame. Hereby the winch frame may be mounted in the stack of counterweight blocks without specific connection means. Accordingly, the winch frame may be mounted to the crane without any specific means except for the means used for mounting the counterweight blocks.

In an embodiment the combination according to the invention is peculiar in that the tagline redirection means are chosen between snatch blocks, connection eyes, shaft connections, roll connections or the like elements allowing the tagline to roll or slide around the redirection means during raising or lowering the load.

The load connection points will in case of the tag lines are attached to the guide wires, desirably be a snatch blocks which allow for a freely rotation and which will allow the tagline to be connected to the load and simultaneously have a redirection which is necessary due to the configuration of the crane boom. The crane boom is normally placed in an oblique condition in relation to a vertical orientation and the bearing wire will, due to gravity influencing on the load have a vertical orientation. However, this vertical orientation may be slightly amended due to the forces exerted on the load.

When the taglines are used for controlling the load there will be exerted a pull towards e.g. the crane boom and/or spools whereby the bearing wire will have a small degree deviating from a vertical orientation.

If a mast redirection point is arranged between each of the rotational spools and respective first and second load connection point a further control point may be achieved.

The load connection points may also be provided in form of connecting eyes or shaft connections which allow the tagline to slide freely through the redirection means upon the actions effected when the load is raised or lowered. Hereby the taglines control the orientation and simultaneously will be guiding the load due to the connection between the taglines and the load connection points.

In general, it is desirable that the load connection points are arranged at the lower side of the load. However, load connection points may also be arranged at the upper side of the load.

When having the load connection points arranged at a lower side of the load there is less requirements for the height of the crane boom.

The load connection points need not to be connected directly to the load. The load connection points could be indirectly connected with the load via a yoke. In an embodiment it is possible to use traditional yokes which will normally be used when installing blades in wind turbines.

Due to a relatively large distance between the winch and the load the two taglines between the tagline load connection points and the winches may be arranged with a relatively small mutual angle, e.g. between 20° and 30°.

The size of the angle is not important: however, it will provide a small control of the movement of the load in a direction being transversal to the direction directed against the crane boom.

What is of more importance is the distance between the attachment means arranged at the load.

Especially in a lower zone of the crane boom it is advantageous to have a long distance between the load connection points as a high horizontal control is obtained.

A longer distance between the load connection points provides for more stability/control as the product of force and distance is influencing on the control of the load.

In a mid zone of the crane boom it is also advantageous to have a long distance between the load connection points as a high horizontal control is obtained. In the mid zone a horizontal control of the load is obtained which is lower than the control in the lower zone.

The best control with the load may be obtained when there is a certain distance between the load connection points means which is larger than the distance between the two winches arranged on the crane.

Moreover, the mutual distance between the two tagline load connection points may often be larger than the mutual distance between the attachment points at the guide wire.

When using the combination for installation of blades in wind turbines a normal distance between the load connection points is between 8 and 20 m. For such distance it has shown that the mutual distance between the two winches should be between 4 and 12 m. Here it should be remembered that also the above-mentioned mutual angle should be observed and that such mutual angle is obtained when having the mutual distances between the redirection means and the winches, respectively.

In an embodiment the combination according to the invention is peculiar in that the combination comprises a control system and that the winches are controlled by the control system.

### BRIEF DESCRIPTION

Some of the embodiments will be described in detail, with references to the following Figures, wherein like designations denote like members, wherein:

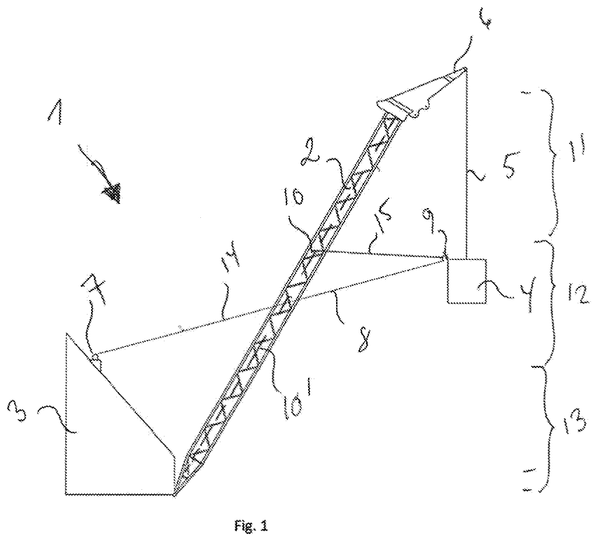

FIG. 1 shows a schematic view of a combination according to embodiments of the present invention comprising a crane and a crane boom provided with a load guiding arrangement;

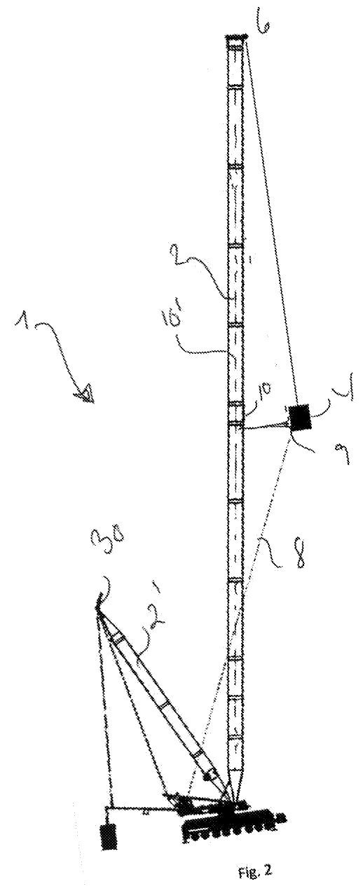

FIG. 2 illustrates a schematic view of a crane provided with a load guiding arrangement and illustrating a top zone, a mid zone and a lower zone for the crane boom;

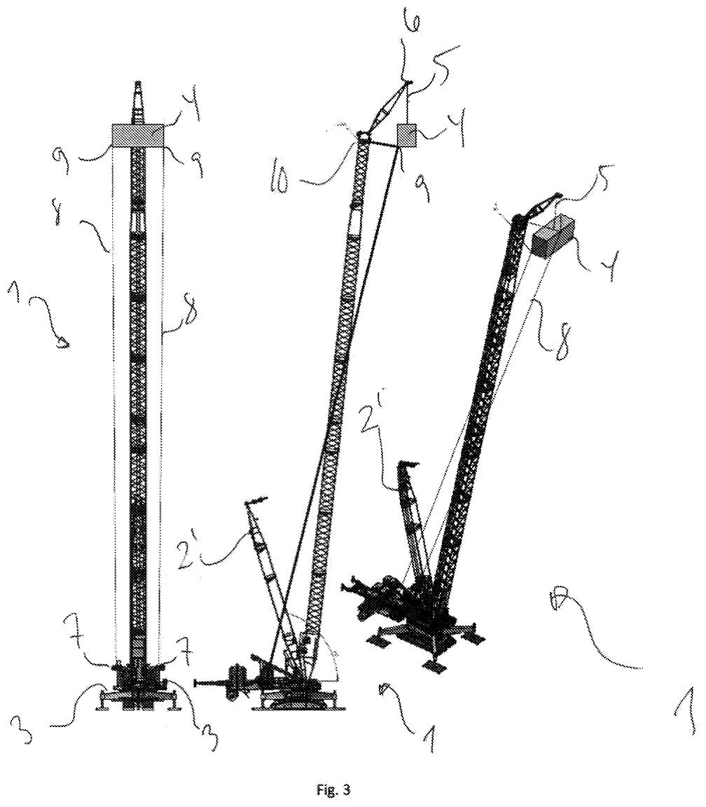

FIG. 3 illustrates different views of a combination according to embodiments of the present invention comprising a crane and a load guiding arrangement and with a load arranged at the top zone of the crane boom;

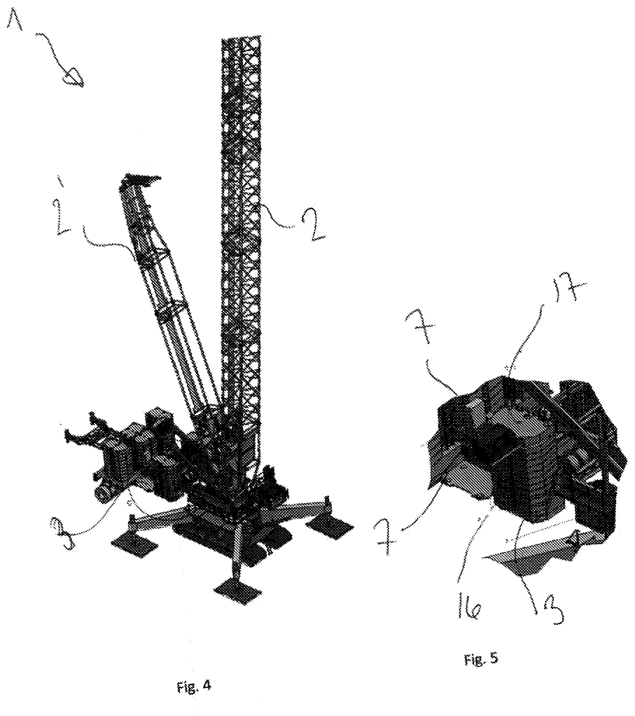

FIG. 4 illustrates a schematically partial view of the crane with a part of the crane boom for the illustration of the mounting of the winch;

FIG. 5 illustrates an enlarged partial view from FIG. 4 to illustrate more clearly the mounting of the winch;

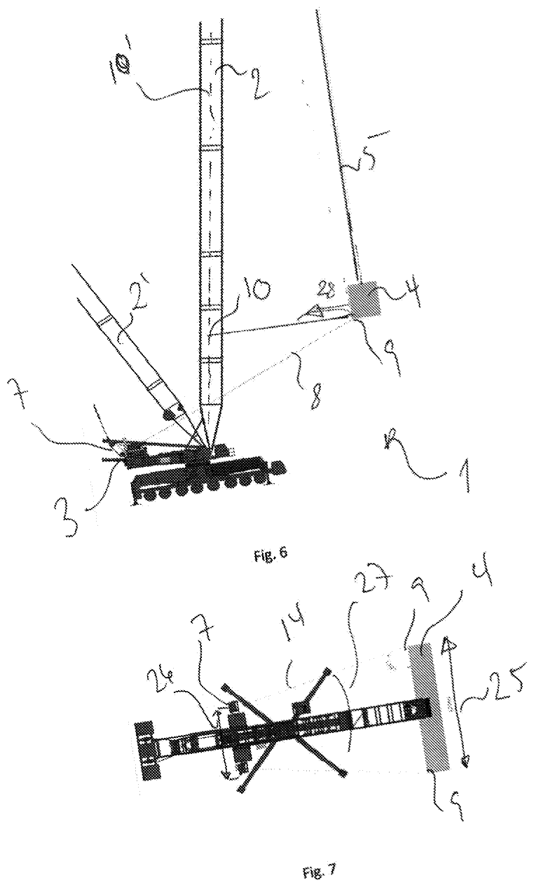

FIG. 6 is a partial side view for illustration of forces stabilising the load against rotation in a lower zone;

FIG. 7 is a top view of the situation illustrated in FIG. 6;

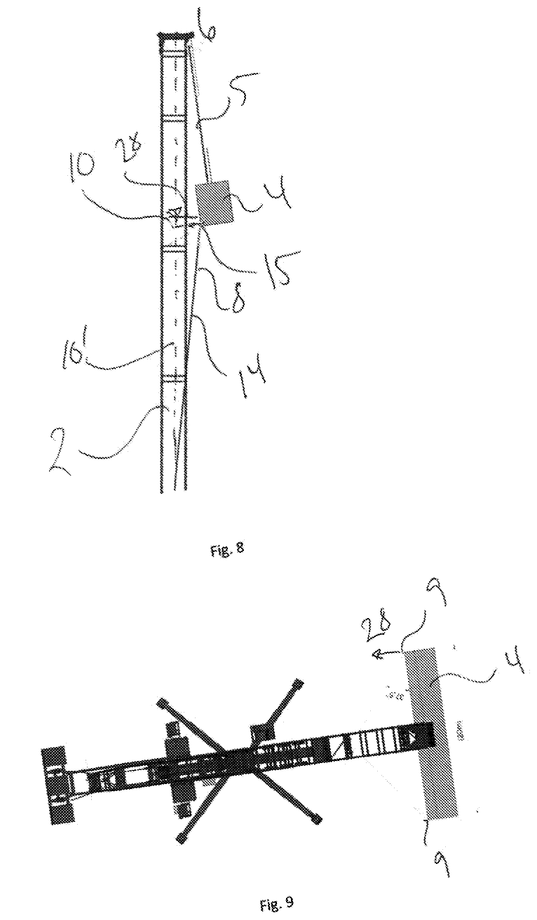

FIG. 8 is a partial side view for illustration of forces stabilising the load against rotation in a top zone;

FIG. 9 is a top view of the situation illustrated in FIG. 8;

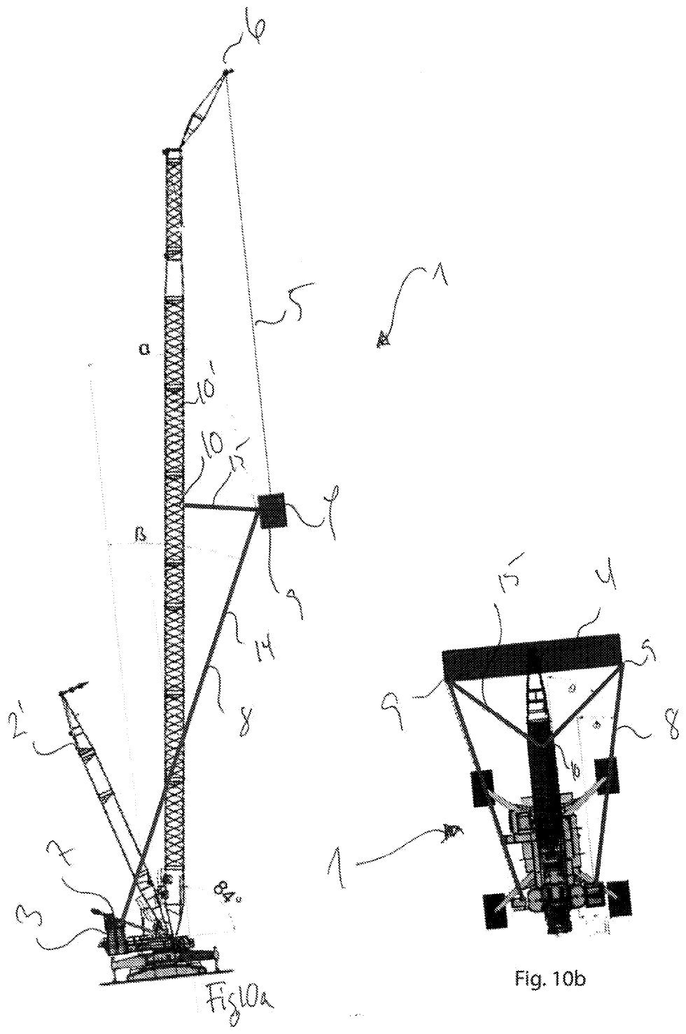

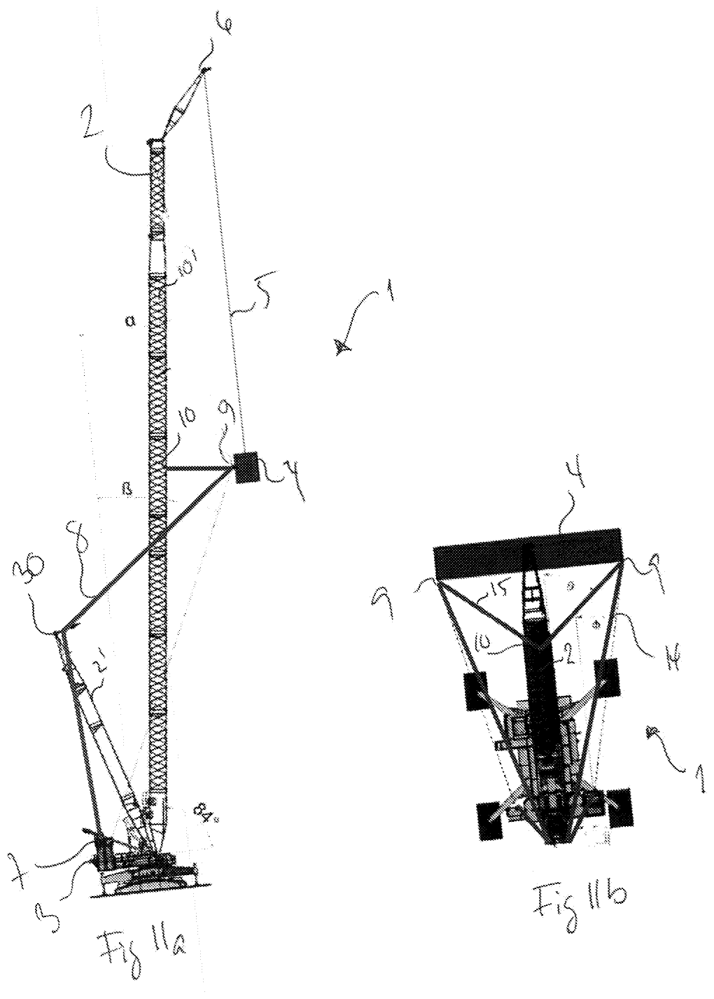

FIG. 10a illustrates a first embodiment wherein the second end of the tag line is attached to the guide wire;

FIG. 10b illustrates a first embodiment wherein the second end of the tag line is attached to the guide wire;

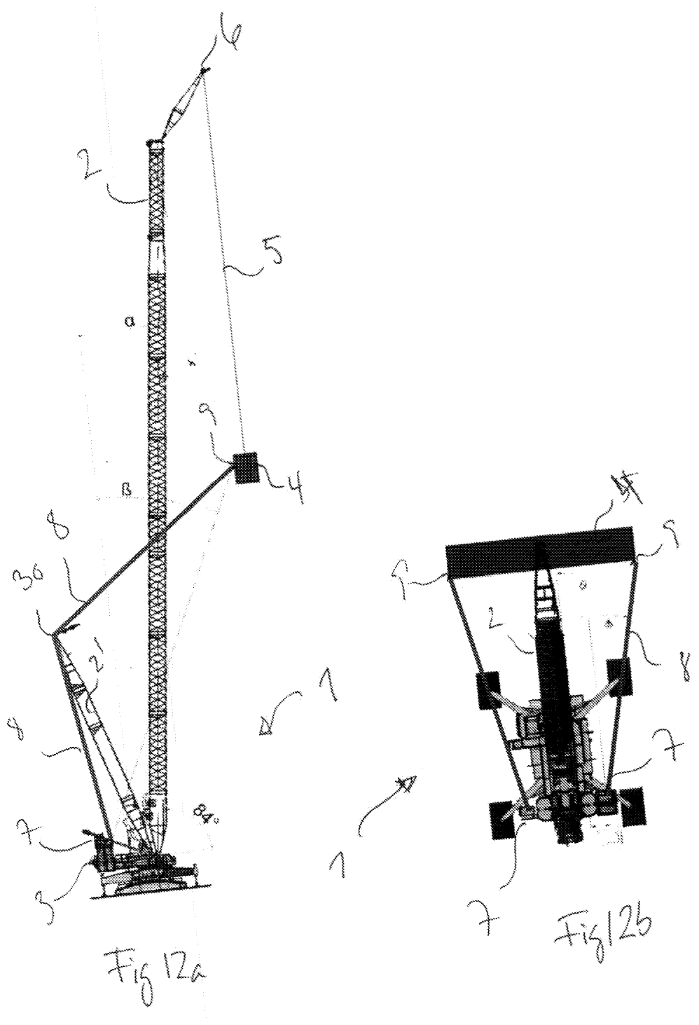

FIG. 11a illustrates a second embodiment wherein the second end of the tag line is attached to the guide wire;

FIG. 11b illustrates a second embodiment wherein the second end of the tag line is attached to the guide wire;

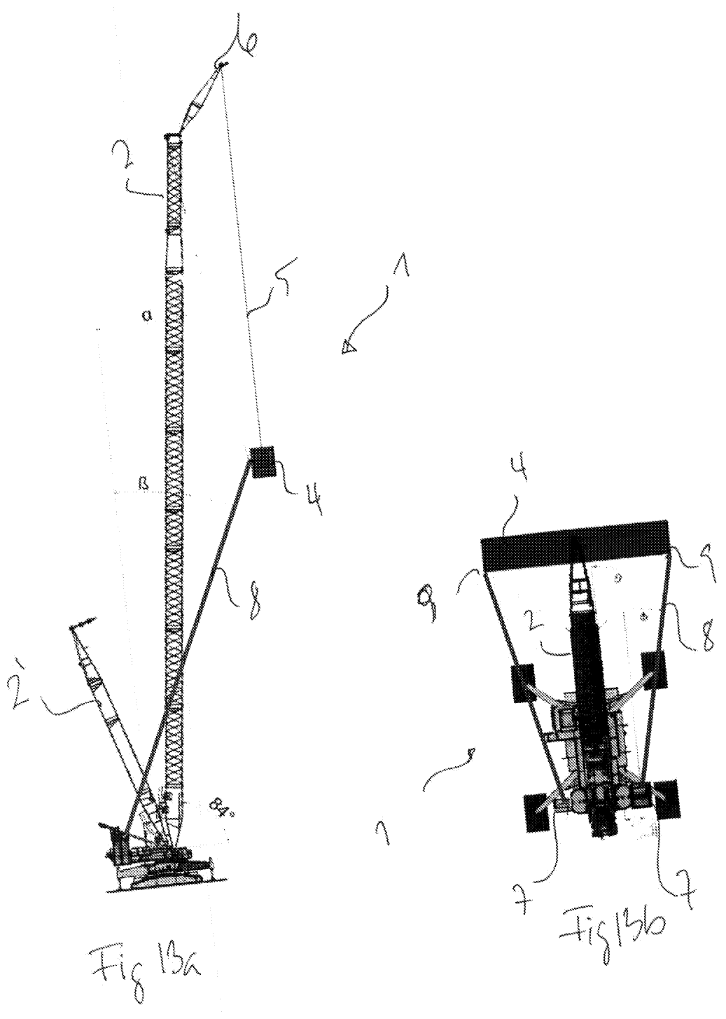

FIG. 12a illustrates a first embodiment wherein the second end of the tag line is attached to the load connection points;

FIG. 12b illustrates a first embodiment wherein the second end of the tag line is attached to the load connection points;

FIG. 13a illustrates a second embodiment wherein the second end of the tag line is attached to the load connection points; and

FIG. 13b illustrates a second embodiment wherein the second end of the tag line is attached to the load connection points.

### DETAILED DESCRIPTION

FIG. 1 illustrates schematically a crane 1 provided with a crane boom 2 and a crane counterweight 3. A load 4 is suspended in the crane boom 2 from a bearing wire 5 running from a top 6 of the crane boom.

A guiding arrangement comprises two winches 7 each attached to the counterweight 3, two taglines 8, two load attachment points 9 at the load 4 and two guide wires attached to the crane boom 2. The crane boom has a top zone 11 has a mid zone 12 and a lower zone 13. Each of these three zones may constitute app ⅓ of the height of the crane boom.

The tagline 8 comprises a lower part 14 arranged between the winch 7 and load attachment points 9 and an upper part 15 arranged between the load attachment points 9 and the attachment point10.

Accordingly, the tagline 8 in the present embodiment has a first end 8′ which is attached to the winch 7 and a second end 8″ which is attached to the attachment point10.

In FIG. 1 only one tagline, one winch, one redirection means, and one attachment point is shown. However, the load guiding arrangement will comprise two of each of these elements which are arranged with a mutual distance as explained below.

FIG. 2 illustrates with more detail the crane 1 and illustrates a situation where the load 4 is arranged in the mid zone 12 of the crane boom.

FIG. 3 illustrates a view seen from the front, from the side and a perspective view of a crane 1 with a guiding arrangement and with a load 4 arranged in the top zone at the top of the crane boom 2. Each attachment point 10 is arranged in an attachment position which substantially is provided at a height corresponding to the height of the position of the load 4.

The situation illustrated in FIG. 3 is a typical situation where the load arranged in the top zone is in a position where main control is needed. Especially for blade installations in wind turbines main control is needed at the height of a hub for the wind turbine (not illustrated).

It occurs from FIG. 3 that the upper part 15 of the taglines 8 is substantially horizontal and the lower part 14 of the taglines is substantially vertical. Therefore, the forces of the upper part 15 of the taglines will give the best control of the load 4. However, also a control in a vertical direction is established due to the effect of the lower part 14 of the taglines. Thus, it is possible to have a secure control of the load 4 which is suspended in the bearing wire 5 and is able to rotate around the bearing wire 5.

The control in the horizontal plane is the most important whereas the control for a pivoting in a vertical plane is less important. Accordingly, it is important to have the main control in the vertical plane which is obtained when the upper part 15 of the taglines 8 is substantially horizontal.

FIGS. 4 and 5 show in more detail the placement of the winch 7 at the counterweight 3. The winch 7 is mounted on a winch plate 16. The winch plate 16 is embodied and arranged for a mounting directly in the counterweight 3.

As it seen a counterweight block 17 is arranged on the top of the winch plate 16. Accordingly, there need no specific arrangement for attaching the winch to the crane and the winch mounted on the winch plate 16 is mounted to the crane simultaneously with the stack of counterweight blocks 17.

As it occurs from FIGS. 4 and 5 a winch 7 is arranged on each side of the crane even though only one of the winches 7 is visible in FIGS. 4 and 5.

In FIG. 5 a control box 18 is visible which is used for automatic controlling the taglines based on tension sensors or other sensors giving a signal to the control box 18 which calculates the necessary rotation of the motors being a part of the winches 7 in order to rotate the rotational spool of the winches.

Alternatively, the rotation of the winch 7 may be controlled manually by an operator.

FIGS. 6 and 7 illustrate the stabilization of the load against rotation when the load 4 is in the lower zone 13. The redirection means 19 are arranged with a mutual distance 25 which may e.g. be 20 m. The winches 7 are arranged with a mutual distance 26 which may e.g. be 12 m. Hereby an angle 27 is formed between the two lower parts of the taglines which is in the size of 20-24°.

As it is especially clear from FIG. 6 the lower part 14 of the taglines is substantially horizontal. Accordingly, a force 28 is mainly directed in horizontal plane and has an action on the load 4 at each of the redirection means 9. Hereby the control in horizontal plane is very efficient against rotation.

A minor force in vertical direction is also provided, seeing that the lower part 14 of the tagline has an oblique orientation in relation to a horizontal plane.

FIGS. 8 and 9 correspond to FIGS. 6 and 7 however, illustrating the stabilization of the load in the top zone 11.

The forces 28 in a horizontal direction will be very important in direction towards the crane boom. In general, the angle 29 between the two upper parts 14 of the taglines will vary between 90° to 30°. The deviation of the angle of the upper part 14 in relation to a horizontal plane will be very limited, typically less than 30°. Accordingly, a high force 28 acting in horizontal plane is obtained. This ensures a very good stabilization of the load against rotation in the horizontal plane around the bearing wire 5.

FIG. 10a is a side view of an embodiment where the tag line 8 extends from the winch 7, to the load 4 via the load connection pints 9 and further to the attachment point 10 at the guide wire.

FIG. 10b is a top view of the combination in FIG. 10a.

FIG. 11a is a side view of an embodiment where the tag line 8 extends from the winch 7, over a mast redirection point 30 at a mast 2′, to the load 4 via the load connection pints 9 and further to the attachment point 10 at the guide wire.

FIG. 11b is a top view of the combination in FIG. 11a.

FIG. 12a is a side view of an embodiment where the tag line 8 extends from the winch 7, over a mast redirection point 30 at a mast 2′, to the load 4 via the load connection pints 9. I.e. here the tag line does not connect to the guide view 10′

FIG. 12b is a top view of the combination in FIG. 12a.

FIG. 13a is a side view of a very simple embodiment according to the present where the tag line 8 extends from the winch 7, to the load 4 via the load connection pints 9. I.e. here the tag line does not connect to the guide view 10′

FIG. 13b is a top view of the combination in FIG. 13a.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module. cm 1. A combination comprising a crane (1) and a load guiding arrangement arranged for mounting to the crane, which crane (1) comprises a crane boom (2) and which load guiding arrangement is arranged for controlling the orientation of a load (4) suspended in a crane boom from a bearing wire (5) about said bearing wire, which combination comprises:
two winches (7), each of said winches has a bi-directional rotational spool, wherein the winches are placed on the crane,
two taglines (8) with a first end of the tagline attached to the rotational spool, wherein each tagline is connected to the load (4) in a first and a second connection point respectively for applying a controlled torque to the load about the bearing wire (5), and
   each tagline is connected with the load through the first and second load connection points so that each tagline extend at least from the spool to the respective first and second attachment point, characterised in that the combination furthermore comprises:
a crane counterweight (3) and
for each winch (7) a winch frame (16), which is mounted directly on the crane next to or on the crane counterweight (3) in positions at each side of the crane (1).

2. A combination according to claim 1, characterized in that at least one guide wire is arranged on the crane.

3. A combination according to any of claim 1 or 2, characterized in that a second end of each of the tag lines is fastened to the respective first or second load connection point or in that the second end of the tag lines is attached to the at least one guide wire in an attachment point.

4. A combination according to any of the preceding claims, characterised in that each winch frame (16) is designed with a form corresponding the form of counterweight blocks (17) and is attached to the crane counterweight (3) in a position between the counterweight blocks (17).

5. A combination according to any of the preceding claims, characterised in that the tagline load connection points are chosen between snatch blocks, connection eyes, shaft connections, roll connections or the like elements allowing the tagline to roll or slide around the redirection means during raising or lowering the load or to releasable fasten the second end of the tag lines to the load.

6. A combination according to any of the preceding claims, characterised in that the attachment point is movable along the at least one guide wire, whereby the attachment point may follow the vertical position of the load as the load is lifted and/or lowered.

7. A combination according to any of the preceding claims, characterised in that it furthermore comprises a yoke for supporting the load (4) and that the two tagline load connection points s (9) are connected with the load via the yoke.

8. A combination according to any of the preceding claims, characterised in that the mutual distance between the two tagline load connection points is larger than the mutual distance between the two winches (7).

9. A combination according to claim 8, characterised in that the mutual distance between the two tagline load connection points is between 8 and 20 m and/or that the mutual distance between the two winches (7) is between 4 and 12 m.

10. A combination according to any of the preceding claims, characterised in that the combination comprises a control system (18) and that the winches (7) are controlled by the control system.

11. A combination according to any of the preceding claims, characterised in that at mast redirection point is arranged between each of the rotational spools and each of the first and second load connection point.

12. Use of a load guiding arrangement in a combination according to any of the preceding claims wherein the load guiding arrangement is arranged for mounting to the crane (1), and that the load guiding arrangement comprises:
two winches (7), each of said winches has a bi-directional rotational spool, wherein the winches are placed on the crane,
two taglines (8) with a first end of the tagline attached to the spool, wherein each tagline is connected to the load (4) for applying a controlled torque to the load about the bearing wire (5),
attachment points (10) at the at least one guide wires, and
two tagline load connection points (9), for example snatch blocks which are connected with the load (4), wherein the load connection points (9) allow the tagline to roll or slide around the redirection means while the load (4) is raised or lowered and simultaneously provides for a redirection of the tagline, whereby each tagline is connected with the load through the redirection means so that each tagline extend from the spool to the attachment bracket (10) via the load connection points (9),
for each winch (7) a winch frame (16), which is arranged for mounting directly on the crane next to or on the crane counterweight (3) in positions at each side of the crane (1).
